(19) United States
(12) Patent Application Publication
(10) Pub. No.: US 2001/0009720 A1
(43) Pub. Date: Jul. 26, 2001

(54) Structure having high quality appearance, and process for producing same

(75) Inventors: Makoto Nagata, Ichihara-shi (JP); Satoru Sogabe, Sodegaura-shi (JP)

Correspondence Address: BIRCH STEWART KOLASCH & BIRCH, PO BOX 747, FALLS CHURCH, VA, 22040-0747, US

(73) Assignee: Sumitomo Chemical Company, Limited

(21) Appl. No.: 09/791,741

(22) Filed: Feb. 26, 2001

Related U.S. Application Data
(62) Division of application No. 09/217,999, filed on Dec. 22, 1998.

(30) Foreign Application Priority Data
Dec. 25, 1997 (JP) 09-357879
May 11, 1998 (JP) 10-127291

(51) Int. Cl. B32B 9/04; B29C 45/14; B29C 45/16

(52) U.S. Cl. 428/411.1; 264/135; 264/511; 264/510; 264/259

(57) ABSTRACT

There is provided a structure of a high quality appearance formed by adhesion of a substrate of a polyolefin resin with a film of an acrylic resin at the back side thereof with use of an adhesive agent, the film being formed by an extrusion molding method and a surface of the film being not lower than 80% in a 60° specular glossiness, which satisfies all properties of surface glossiness, scratch resistance, transparency and weatherability at the same time.

The present invention relates to a structure having a high quality appearance formed by adhesion of a substrate of a polyolefin resin with a specific film of an acrylic resin at the back side thereof, and a process for producing the same.

A kind of a structure having a high quality appearance is known in Japanese Patent Kokai (JP-A-) 3-150156, wherein there is disclosed a molded laminate formed by laminating a skin layer on a surface of a molded bone of a synthetic resin mainly comprising a polyolefin resin through a specific primer layer, the skin layer being a skin film formed from at least one synthetic resin selected from ABS resins, polyamides, polyurethanes and polyvinyl chloride resins.

However, the molded laminate disclosed in the Japanese Patent Kokai can hardly meet needs to satisfy all of surface glossiness, scratch resistance, transparency and weatherability at the same time, because the skin layer is composed of ABS resins, polyamides, polyurethanes or polyvinyl chloride resins. The properties are required to be satisfied all at the same time, when the molded laminate is applied for uses such as, for example, interior or exterior car parts.

An object of the present invention is to provide a structure capable of satisfying all the properties at the same time, and a process for producing the same.

The present inventors have undertaken a study on a structure obtained by adhesion of a substrate of a polyolefin resin with a film and capable of satisfying all the properties at the same time. As a result, the inventors have found a fact that a structure satisfying all the properties at the same time can be obtained by using a specific film, and attained to the present invention.

The present invention provides a structure formed by adhesion of a substrate of a polyolefin resin with a film of an acrylic resin at the back side thereof with use of an adhesive agent, the film being formed by an extrusion molding method, and a surface of the film being not lower than 80% in a 60° specular glossiness.

The present invention also provides a process for producing a structure, which comprises the following steps;

Step 1 : coating an adhesive agent on the back side of a film of an acrylic resin and then drying the film, the film being formed by an extrusion molding method, and a surface of the film being not lower than 80% in a 60 specular glossiness,

Step 2 : fixing the film dried to a mold for an extrusion molding so as to bring the adhesive agent-free surface of the film into close contact with an inner wall of the mold, and

Step 3 : injecting a polyolefin resin on the film fixed.

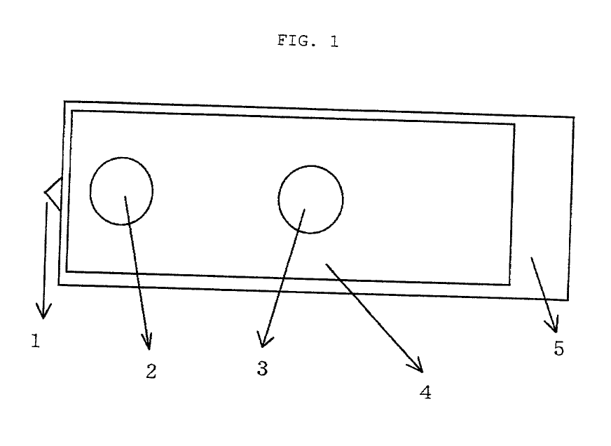

FIG. 1 shows a plan view of the structure in accordance with the present invention.

In FIG. 1, reference numeral 1 denotes a gate, reference numeral 2 denotes a position for measuring an adhesion strength, reference numeral 3 denotes a position for measuring a 60° specular glossiness, reference numeral 4 denotes a film of an acrylic resin and reference numeral 5 denotes a substrate.

A shape of the substrate constituting the structure in accordance with present invention is not particularly limited. It may be of, for example, interior or exterior car parts or signboards, and can be determined arbitrarily depending on uses of the structure.

The polyolefin resin used for the substrate constituting the present structure is that capable of being molded by an extrusion molding method, an injection molding method, a blow molding method and others which are known in the field of molding of thermoplastic resins, and includes a homopolymer or copolymer of an α-olefin such as ethylene and propylene; a copolymer of an α-olefin with another monomer, providing that the copolymer has a repeating unit derived from the α-olefin as a main component; a mixture of the (co)polymers; and a composition comprising the (co)polymers or the mixture and a modifier such as elastomers and fillers.

Examples of the polyolefin resin are polyethylene resins; polypropylene resins; polybutene; poly-4-methyl-pentene-1; copolymers prepared by copolymerizing ethylene with at least two monomers selected from the group consisting of α-olefins having 3 or more carbon atoms; and mixtures thereof with a small amount of styrenic elastomers, inorganic fillers and the like.

The α-olefins having 3 or more carbon atoms include those having 3 to 20 carbon atoms such as propylene, butene-1, pentene-1, hexene-1, octene-1, decene-1, and octadecene-1.

Examples of the copolymers prepared by copolymerizing ethylene with at least two monomers selected from the group consisting of α-olefins having 3 or more carbon atoms are propylene-ethylene block copolymer, and propylene-ethylene-butene-1 block copolymer.

The polyethylene resin includes an ethylene homopolymer; a copolymer prepared by polymerizing ethylene with at least one monomerselected from the group consisting of α-olefins having 3 or more carbon atoms and other monomers, providing that the copolymer has a repeating unit derived from ethylene as a main component; and a mixture of the homopolymer and the copolymer.

Examples of the polyethylene resin are a low density polyethylene produced by a radical polymerization method, a high density polyethylene produced by an ionic polymerization method, and an ethylene-α-olefin copolymer produced by copolymerizing ethylene with an α-olefin according to a known radical or ionic polymerization method. Examples of the α-olefin are those having 3 to 18 carbon atoms, such as propylene, butene-1, 4-methyl-pentene-1, hexene-1, octene-1, decene-1 and octadecene-1. These α-olefins are used singly or in a mixture of two or more, and a content of the α-olefin is usually from 5 to 98% by weight.

The polypropylene resin includes a propylene homopolymer; a copolymer of propylene with at least one monomer selected from the group consisting of ethylene, α-olefins having 4 or more carbon atoms and other monomers, providing that the copolymer has a repeating unit derived from propylene as a main component; and a mixture of the homopolymer and the copolymer.

Examples of the polypropylene resin are a propylene homopolymer, a propylene-ethylene copolymer, a propylene-butene-1 copolymer, a propylene-ethylene-butene-1 terpolymer and the other propylene-α-olefin copolymers. Those exemplified above as the α-olefins copolymerized with ethylene are also exemplified as the α-olefins to be copolymerized with propylene, and the α-olefins can be used singly or in a mixture of two or more. The propylene resin can be produced by any known method, such as, for example, an ionic polymerization method.

From a viewpoint of obtaining a structure having a low mold shrinkage, a polyolefin resin composition mainly comprising a polypropylene resin and having a coefficient of linear thermal expansion of not more than 1.0×10⁻⁴ (1/° C.) measured at 20 to 100° C. is preferably used as the polyolefin resin. In order to prepare the low mold shrinkage resin composition mainly comprising the polyolefin resin, the polyolefin resin may comprise 5 to 40% by weight of inorganic fillers such as talc or the like.

As occasion demands, the polyolefin resin may contain lustrous particles such as mica covered with aluminum or titanium oxide, and pigments used usually in the field of the resin composition. When the polyolefin resin comprising the lustrous particles is used, the resulting structure has a surface of a deep appearance, even if no printing is applied at the underside of the film of the acrylic resin.

The polyolefin resin can be produced by a known method. Polymerization catalysts used for the production thereof are not particularly limited. For example, solid catalysts and metallocene type homogeneous catalysts can be used.

The acrylic resin for the film of the acrylic resin constituting the structure in accordance with the present invention includes a resin comprising a polymer obtained from acrylic acid, methacrylic acid or an ester thereof as a main component and a mixture of two or more of the resin.

A preferred acrylic resin is a resin comprising 10 to 70% by weight of an acrylic resin (X) having a 6-membered ring acid anhydride unit represented by the following formula [I] in the molecule, the acrylic resin (X) being obtained by modifying a polymer obtained from acrylic acid, methacrylic acid or an ester thereof. Examples of the (meth)acrylic ester are methyl acrylate, ethyl acrylate, methyl methacrylate, ethyl methacrylate, cyclohexyl methacrylate and benzyl methacrylate. These esters may be used singly or in a mixture of two or more.

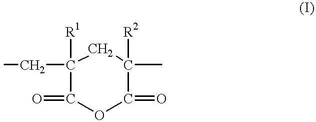

In the formula, R¹ and R² are the same or different and stand for a hydrogen atom or an alkyl group. When at least one of R¹ and R² stands for an alkyl group, methyl, ethyl, propyl, isopropyl, butyl, t-butyl, sec-butyl and amyl groups are exemplified as the alkyl group.

The acrylic resin (X) having the 6-membered ring acid anhydride unit [I] can be obtained by heat-treating the polymer obtained from acrylic acid, methacrylic acid or an ester thereof at a temperature of 150 to 350° C., preferably 220 to 320° C., in the presence of a base compound such as sodium hydroxide, potassium hydroxide, sodium methylate and the like, as disclosed in Japanese Patent Kokai(JP-A-) 7-268036.

A content of the 6-membered ring acid anhydride unit [I] in the acrylic resin (X) is preferably from 3 to 30% by weight, more preferably from 5 to 25% by weight. When the content is less than 3% by weight, an improvement of a thermal resistance attributed to the acrylic resin (X) may become insufficient. Whereas, when the content exceeds 30% by weight, a melt viscosity of the acrylic resin (X) may increase greatly, resulting in insufficient molding processability.

A more preferred acrylic resin is a resin comprising 10 to 70% by weight of an acrylic resin (Y) comprising 50 to 95% by weight of an acrylic resin having a glass transition temperature of 60 to 110° C. and a weight average molecular weight of 70,000 to 600,000, and 5 to 50% by weight of an acrylic polymer of a multilayered structure comprising a layer of rubber elasticity.

Examples of the acrylic polymer of the multilayered structure comprising the layer of rubber elasticity are an acrylic polymer of a two-layered structure having as an inner layer a layer of rubber elasticity formed from a copolymer of an alkyl acrylate with a polyfunctional monomer, the alkyl in the alkyl acrylate having 4 to 8 carbon atoms, and as an outer layer a hard polymer comprising methyl methacrylate as a main component, and an acrylic polymer of a three-layered structure having as an innermost layer a hard polymer comprising methyl methacrylate as a main component, as an intermediate layer a layer of rubber elasticity formed from a copolymer of an alkyl acrylate with a polyfunctional monomer, the alkyl in the alkyl acrylate having 4 to 8 carbon atoms, and as an outermost layer a hard polymer comprising methyl methacrylate as a main component. These acrylic polymers of a multilayered structure can be prepared by the method described in, for example, Japanese Patent Publication (JP-B-) 55-27576.

A surface of the film of the acrylic resin in the structure in accordance with the present invention is not lower than 80%, preferably not less than 90%, in a 60° specular glossiness. A decoration degree of the resulting structure increases with increase in the value of the 60° specular glossiness. The 60° specular glossiness can be measured by the method prescribed in JIS-K-7105.

The film of the acrylic resin has a thickness of usually from 30 to 700 μm, preferably from 40 to 300 μm, more preferably from 80 to 250 μm. The thickness can be measured by a micrometer. When the thickness is less than 30 μm, the surface of the film of the resulting structure may be easily scratched. When the thickness exceeds 700 μm, it may become difficult to accompany the film accurately with a finely rugged surface of the substrate to complete an adhesion, or even if the adhesion could be completed, the resulting structure should show a warp.

The film of the acrylic resin may be a monolayer film or a multilayer film. As the monolayer film, a monolayer film of a clear acrylic resin and a monolayer film of a colored acrylic resin are exemplified. As the multilayer film, a two-layer film formed by laminating a film of a clear acrylic resin with a film of a colored acrylic resin, and a three-layer film formed by laminating a film of a clear acrylic resin, a film of an acrylic resin having a printed surface and a film of a colored acrylic resin in this order are exemplified.

When the multilayer film is used as the film of the acrylic resin, the resulting structure has a surface of a deep appearance. The deep appearance is due to a high clarity which is a characteristic feature of the acrylic resin, and can be observed when the colored or printed surface of the structure or the surface of a lustrous particle-containing substrate of the structure is viewed from the decorative side thereof, namely from the side of the film of the clear acrylic resin. In the case where the film of the acrylic resin is the multilayer film and possesses both a decorated surface and a non-decorated surface, the adhesion is performed in a manner such that the surface of the substrate is touched to the non-decorated surface (the back side) of the multilayer film.

The film of the acrylic resin in the structure in accordance with the present invention is the one prepared by forming the acrylic resin into a film by an extrusion molding method such as T die extrusion molding method or calendering method. From a viewpoint of a thickness precision and a surface glossiness (that is, surface smoothness) of the resulting film, it is preferred to carry out the extrusion molding method in a manner such that both surfaces of the film extruded are brought into contact with the surface of a roller having a substantially smooth surface, or both surfaces of the film extruded are brought into contact with the surface of a metal belt having a substantially smooth surface. Any foreign matter even having a small particle size such as not more than 100 μm easily affects a look of the resulting film and a printability to the resulting film. In order to prevent the film from being contaminated with the foreign matter during the film formation process, it is preferred to arrange a metal- or sintering ceramic-made screen mesh in a passage of the molten acrylic resin. As the screen mesh, it is preferred to use, for example, a rotary type screen changer manufactured by Gneuss Co., Ltd. in Germany, because the meshes are hardly clogged, or even when clogged, the meshes can be recovered without a frequent discontinuation of the production process. With use of the said rotary type screen changer, there can be obtained a film substantially freed from a foreign matter having a particle size of not more than 100 μm.

The adhesive agent used for the adhesion of the substrate with the film of the acrylic resin at the back side thereof is not particularly limited. Examples of the adhesive agent usable are chlorinated polypropylenes; polypropylene type resins prepared by graft-copolymerization of polybutadiene having hydroxyl group as a terminal group or hydrogenated product thereof; and hydroxylated polypropylene. Of these, preferred are chlorinated polypropylenes having a chlorination percent of preferably from 10 to 50% by weight, more preferably from 20 to 30% by weight. Those having a chlorination percent of less than 10% by weight or exceeding 50% by weight may result in insufficient adhesion of the substrate with the film of the acrylic resin at the back side thereof.

The structure in accordance with the present invention can be produced in any manner. For example, the back side of the film of the acrylic resin is coated with the adhesive agent and then dried, and using an injection mold provided with a forwarding means of the film, a heating means thereof and a suction means (for example, a vacuum pump), the film is fixed to the mold so as to bring the adhesive agent-free surface of the film into close contact with the inner wall of the mold, and then the polyolefin resin is injected on the film fixed, thereby obtaining the desired structure. Alternatively, the film coated with the adhesive agent at the back side thereof and dried as mentioned above is pre-molded so as to be fitted for a shape of the injection mold with a vacuum molding machine, the pre-molded film is fixed to the injection mold so as to bring the adhesive agent-free surface of the film into close contact with the inner wall of the injection mold, and thereafter the polyolefin resin is injected on the film fixed.

In production of the structure according to the above-mentioned methods, it is expedient to use an adhesive agent such as those (for example, chlorinated polypropylenes) capable of exhibiting no adhesive property at a non-heating stage where the film of the acrylic resin coated with the adhesive agent and dried is fixed to the mold to be closely attached to the inner wall of the mold, and exhibiting a desired adhesive property at a heating stage where the polyolefin resin is injected, because the film coated with the adhesive agent and dried in advance can be stored and transported without any troubles such as adhesion of foreign products with the film.

A structure decorated in a conventional manner through a painting process has been required to have not only a high quality appearance but also a high scratch resistance expressed in terms of a pencil hardness. According to the present invention, the structure having a pencil hardness of B or more, 2H or more, or further 4H or more can be obtained, because the film of an acrylic resin having a high scratch resistance is laminated. Thus, the present structure having a highly decorative surface and a high quality appearance with a high scratch resistance can gain an advantage over a conventional structure.

According to the present invention, a structure of a high quality appearance superior in surface glossiness, scratch resistance, transparency and weatherability can be obtained by adhesion of a substrate of a polyolefin resin with a film of an acrylic resin at the back side thereof with use of an adhesive agent, the film being formed by an extrusion molding method and a surface of the film being not lower than 80% in a 60° specular glossiness.

The structure in accordance with the present invention is particularly suitable for uses such as interior or exterior car parts, electric appliances, parts of miscellaneous goods, signboards and the like. Particularly when the present structure is used for the interior or exterior car parts or the electric appliances, these parts can be provided at low costs, because no painting process is required to create decoration.

The present invention is illustrated in more detail with reference to the following Examples, which are only illustrative, and are not limitative for the scope of the present invention.

The injection molding machine, the mold, the shape of the molded product and the evaluation method used in Examples were as follows.

1. Injection Molding Machine and Mold

Injection molding machine: FS16OS25ASEN manufactured by

Nissei Plastic Industrial Co., Ltd.)

Molding temperature: 225° C.

Mold: 150 mm×300 mm×3 mm (thickness), fan gate

Mold temperature: 52° C. (cavity side, namely side of inserting the film), 55° C. (core side)

2. Glossiness

60° specular glossiness of the surface of the structure obtained was measured by the method prescribed in JIS-K-7105. The measurement was carried out at nearly center of the structure as shown in FIG. 1.

3. Adhesion Strength

The surface of the structure (the side of the film of the acrylic resin) was cross cut in 2×2 mm square using a razor blade to form 100 squares (10 squares in longitudinal direction X 10 squares in lateral direction), and a 24 mm wide plastic adhesive tape (Cello-Tape, a trademark of Nichiban Co., Ltd.) was pressed over the cross cut surface under the finger-pressure and then peeled off in a stroke from the one end of the tape held with fingers. The squares remaining on the surface was counted to determine the adhesion strength between the film of the acrylic resin and the substrate in terms of residual %. The measurement was conducted at the position close by the gate, as shown in FIG. 1, which position was considered to be lowest in the adhesive strength.

4. Pencil Hardness

It was carried out by the pencil scratch test prescribed in JIS-K-5400. The evaluation was carried out according thereto in a manner such that the test was started with use of a pencil of 6 B in hardness, and continued with use of those of 5 B, 4 B and others higher in hardness in order, thereby determining the pencil which first scratched the surface of the structure, and the hardness of the structure was expressed in terms of the hardness of the pencil which first scratched the surface of the structure.

5. Deep Appearance

The surface of the structure was visually evaluated depending on the following sensuous criteria.

5: deep appearance similar to that of a surface of a conventional injection molded product which had been treated by a metallic painting, followed by a clear coating.

4: sufficiently deep appearance, but slightly inferior to 5.

3: certainly deep appearance.

2: deep appearance inferior to 3, not that no deep appearance was observed.

1: absolutely no deep appearance.

6. Coefficient of linear thermal expansion

The coefficient of linear thermal expansion was measured by the method prescribed in JIS-K-7197. Using the foregoing mold, a flat board was injection-molded using no film of the acrylic resin. A center portion of the flat board was cut down in a size of 10 mm×10 mm to prepare the test piece. The coefficient of linear thermal expansion was measured both in the direction of flow and in the direction vertical thereto, and an average value thereof was adopted as the asked coefficient of linear thermal expansion. These values were obtained from a difference between the length obtained at 20° C. and that obtained at 100° C., provided that the test specimen was heated from −20° C. to 120 ° C. at a rate of 5° C./min. using TMA-DT-40 manufactured by Shimadzu Co.,Ltd.

### EXAMPLE 1

Using a single screw extruder of 65 mm diameter, an acrylic resin composition comprising 50% by weight of the following acrylic resin (i) and 50% by weight of the following acrylic resin (ii) was extruded through a T die set up at a temperature of 250° C. and passed through a cooling and polishing roll having a substantially smooth surface, providing that both surfaces of the film extruded were brought into complete contact with the surface of the roll, thereby obtaining a desired film of the acrylic resin having a thickness of 150 μm±30 μm.

(i) An acrylic resin A having an average particle size of 300 nm, and a spherical three-layered structure consisting of an innermost layer of methyl methacrylate cross linking polymer, a intermediate layer of a soft rubber elastomer comprising butyl acrylate as a main component and an outermost layer of methyl methacrylate polymer, as disclosed in Example 3 of Japanese Patent Publication (JP-B-)55-27576.

(ii) A methacrylic resin having 7.8% by weight of the 6-membered ring acid anhydride unit [I], prepared by the method described in Example 1 of Japanese Patent Kokai (JP-A-)7-268036.

The resulting film of the acrylic resin was cut down into 100 mm×250 mm. An adhesive agent was prepared by viscosity-regulating an adhesive (chlorinated polypropylene produced by Nippon Paper Industries Co., Ltd., trade mark Super Chlon 822, chlorination percent: 24.5%, a liquid having a solid content of 20% by weight) with toluene to a viscosity of 7 to 8 seconds/23° C. under a Ford viscosity cup standard. One surface of the film cut down was spray-coated with the adhesive agent at 0.056 g/cm², and then dried at 100° C. for 10 minutes in an oven. The adhesive agent-free surface of the film was brought into close contact with the mold cavity, and then fixed thereto with a double coated adhesive tape. Successively, a polypropylene containing 20% by weight of talc (Sumitomo Noblen BWH42, produced by Sumitomo Chemical Co., Ltd.) was injection-molded on the film to obtain a desired structure. The coefficient of linear thermal expansion of Sumitomo Noblen BWH42 was 8.21×10⁻⁵. The results of evaluation are shown in Table 1.

### EXAMPLE 2

Using a single screw extruder of 65 mm diameter, a mixture of an acrylic resin composition comprising the following acrylic resins (iii), (iv) and (v) in a proportion of 30% by weight, 50% by weight and 20% by weight, respectively, with 0.5 parts by weight of a ultraviolet absorber, ADK STAB LA-31 (high molecular weight benzotriazole type, produced by Asahi Denka Kogyo K.K.) was extruded through a T die set up at a temperature of 250° C., and passed through a cooling and polishing roll having a substantially smooth surface, providing that both surfaces of the film extruded were brought into close contact with the surface of the roll, thereby obtaining a desired film of the acrylic resin having a thickness of 125 μm±5 μm. Thereafter, using the resulting film, Example 1 was repeated to obtain a desired structure. The results of evaluation are shown in Table 1.

(iii) An acrylic resin B of 90% by weight of methyl methacrylate unit and 10% by weight of methyl acrylate unit prepared by a bulk polymerization method, which had a glass transition temperature of 95° C., and a weight average molecular weight of 120,000.

(iv) An acrylic resin C of 80% by weight of methyl methacrylate unit and 20% by weight of butyl acrylate unit, which had a glass transition temperature of 62° C., and a weight average molecular weight of 300,000.

(v) The acrylic resin A (the same as (i) in Example 1)

### COMPARATIVE EXAMPLE 1

A structure was obtained in a manner similar to that of Example 1, provided that neither the film of the acrylic resin nor the adhesive agent was used. The results of evaluation are shown in Table 1.

TABLE 1

| | | | | Comparative |
|---|---|---|---|---|
| Item | Unit | Example 1 | Example 2 | Example 1 |
| Glossiness | % | 93 | 91 | 45 |
| Film Adhesion | % | 100 | 100 | — |
| Pencil Hardness | — | 4H | 2H | B |
| Deep Appearance | — | 5 | 5 | 2 |

In the claims:

1. A process for producing a structure, which comprises the steps of;
(i) coating an adhesive agent on the back side of a film comprising an acrylic resin and then drying the film, the film being formed by an extrusion molding method, and a surface of the film being not lower than 80% in a 60° specular glossiness,
(ii) fixing the film dried to a mold for an extrusion molding so as to bring the adhesive agent-free surface of the film into close contact with an inner wall of the mold, and
(iii) injecting a polyolefin resin on the film fixed.

2. The process for producing a structure according to claim 1, wherein the extrusion molding method is carried out by bringing both surfaces of the film extruded into contact with a surface of a roll having a substantially smooth surface.

3. The process for producing a structure according to claim 1, wherein the extrusion molding method is carried out by bringing both surfaces of the film extruded into contact with a surface of a metal belt having a substantially smooth surface.

4. The process for producing a structure according to claim 1, wherein the acrylic resin comprises a resin which is obtained by modifying a polymer obtained from acrylic acid, methacrylic acid or an ester thereof, and which has a 6-membered ring acid anhydride unit represented by the following formula (I) in the molecule, a content of the 6-membered ring acid anhydride unit being 3 to 30% by weight, the formula being 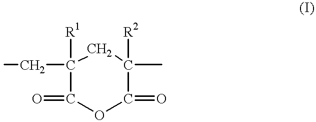
wherein R¹ and R² are the same or different, and stand for a hydrogen atom or an alkyl group.

5. The process for producing a structure according to claim 1, wherein the acrylic resin comprises 50 to 95% by weight of an acrylic resin having a glass transition temperature of from 60 to 110° C. and a weight average molecular weight of 70,000 to 600,000, and 5 to 50% by weight of an acrylic polymer of a multilayered structure comprising a layer of rubber elasticity.

6. The process for producing a structure according to claim 1, wherein the film comprising an acrylic resin has a thickness of from 30 to 700 μm.

7. The process for producing a structure according to claim 1, wherein the film comprising an acrylic resin is a film having a printing layer.

8. The process for producing a structure according to claim 1, wherein the film comprising an acrylic resin has a surface hardness of not lower than B in terms of a pencil hardness.

9. The process for producing a structure according to claim 1, wherein the polyolefin resin comprises a polypropylene resin.

10. The process for producing a structure according to claim 1, wherein the polyolefin resin has a coefficient of linear thermal expansion of not higher than 1.0×10⁻⁴(1/° C.).

11. The process for producing a structure according to claim 1, wherein the adhesive agent comprises a chlorinated polypropylene having a chlorination percent of from 10 to 50% by weight.

12. Interior or exterior car parts comprising a structure obtained according to claim 1.
